(19) United States
(12) Patent Application Publication
(10) Pub. No.: US 2026/0124028 A1
(43) Pub. Date: May 7, 2026

(54) TIP STORAGE FOR ORAL HEALTH DEVICES

(71) Applicant: WATER PIK, INC., Fort Collins, CO (US)

(72) Inventors: Brian R. WILLIAMS, Fort Collins, CO (US); Brian WOODARD, Fort Collins, CO (US)

(73) Assignee: WATER PIK, INC., Fort Collins, CO (US)

(21) Appl. No.: 19/365,641

(22) Filed: Oct. 22, 2025

Related U.S. Application Data
(60) Provisional application No. 63/715,099, filed on Nov. 1, 2024.

(51) Int. Cl. A61C 19/02; A61C 17/02

(52) U.S. Cl. CPC A61C 19/02; A61C 17/0202

(57) ABSTRACT

A handheld oral health device (e.g., a water flosser) may include a body, a reservoir coupled to the body and defining a handle for gripping by the user to hold the handheld device, and an accessory storage associated with the reservoir, the accessory storage configured to store one or more accessories for the handheld device. The accessory storage may be detachable from the handheld device and/or define a storage compartment separate from the body/reservoir. The accessory storage may include an engagement configured for selective attachment to the reservoir. The engagement may include a clip or magnets. The accessory storage may include a hinged or slide closure to selectively close the storage compartment. Venting may be defined at a bottom of the storage compartment. Additional systems and associated methods are also disclosed.

### CROSS-REFERENCE TO RELATED APPLICATIONS

This application claims the benefit of priority to U.S. Provisional Patent Application No. 63/715,099, filed November 1, 2024, the disclosure of which is hereby incorporated by reference in its entirety.

### FIELD

The present disclosure relates to health and personal hygiene equipment, and more particularly, to cordless oral health devices.

### BACKGROUND

Oral health devices, such as water flossers, also referred to as oral irrigators, may be used to clean a user’s teeth and gums by discharging a pressurized, pulsating fluid stream into a user’s oral cavity. The fluid impacts the teeth and gums to remove debris. Water flossers may come in a variety of configurations including countertop models that are powered by an alternating current outlet as well as handheld models that are battery powered and are self-contained, meaning that all components, including the reservoir, are contained in or are immediately associated with a hand-holdable body. Different configurations provide different advantages. Often many irrigators include accessories, such as different types of tips, tips for different users, or the like. Many times such accessories may be misplaced or lost as they are not coupled to the unit when not in use. Such misplacement increases with portable units, such as handheld units, that may be moved more readily between locations.

### BRIEF SUMMARY

In one example, a handheld oral health device includes a body, a reservoir coupled to the body and defining a handle for gripping by the user to hold the handheld oral health device, and an accessory storage associated with the reservoir, the accessory storage configured to store one or more accessories for the handheld oral health device.

Optionally, the accessory storage includes side portions shaped to fit around at least a portion of the reservoir, and wherein the side portions selectively engage the reservoir to couple the accessory storage to the reservoir. The side portions may be configured to snap onto the reservoir through clip and groove features.

Optionally, the accessory storage is molded into a side of the reservoir. The handheld oral health device may include a lid to selectively close a top of the accessory storage, and venting defined at a bottom of the accessory storage. The accessory storage may be molded into a back side or a left or right side of the reservoir.

Optionally, the accessory storage is configured to clip onto the reservoir in multiple locations. The accessory storage may include first and second clips shaped to fit around and engage at least portions of the reservoir. The accessory storage may include a lid that opens to allow access to the one or more accessories. The lid may include a closure that is snap or magnetic.

Optionally, the accessory storage is coupled to the reservoir using magnets.

Optionally, the reservoir is removable from the body.

In another example, a handheld device for oral health includes a body, and an accessory storage associated with the body and configured to store one or more accessories for the handheld device, wherein the accessory storage is detachable from the body and/or defines a storage compartment separate from the body.

Optionally, the accessory storage snaps onto the body.

Optionally, the accessory storage is magnetically coupled to the body.

Optionally, the accessory storage includes a hinged or slide closure.

Optionally, the body includes a handheld reservoir, and the accessory storage is detachable from the reservoir and/or defines a storage compartment separate from the reservoir.

Optionally, the body includes a handle, and the accessory storage is detachable from the handle and/or defines a storage compartment separate from the handle.

Optionally, the handheld device is a water flosser or an electric toothbrush.

In another example, an accessory storage configured for selective attachment to a reservoir of a handheld oral health device is provided, the reservoir defining a handle for holding the handheld oral health device. The accessory storage includes an engagement configured for selective attachment to the reservoir, and a storage to receive and hold one or more accessories for the handheld oral health device.

Optionally, the engagement includes a clip configured to snap into a corresponding groove or notch of the reservoir.

Optionally, the engagement includes magnets to magnetically couple the accessory storage to the reservoir.

Optionally, the storage includes one or more grooves to receive and hold the one or more accessories.

Optionally, the storage includes a compartment to receive the one or more accessories, and a hinged or slide closure configured to selectively close the compartment. The closure may be snap or magnetic.

In another example, an accessory storage for a handheld oral health device includes an engagement configured for selective attachment to a portion of the handheld oral health device that is gripped by the user, a compartment configured to receive one or more accessories for the handheld oral health device, and venting defined at a bottom of the compartment to drain liquid away from the handheld oral health device.

Optionally, the venting includes slots or holes.

Optionally, the accessory storage includes a closure configured to allow selective access to the one or more accessories in the compartment. The closure may be hinged at a top or a bottom of the compartment.

Optionally, the handheld oral health device is a water flosser or an electric toothbrush.

In another example, a method includes selectively coupling an accessory storage to a body of a handheld oral health device, the accessory storage configured to store one or more accessories for the handheld oral health device.

Optionally, the selectively coupling includes snapping the accessory storage onto the body.

Optionally, the selectively coupling includes magnetically coupling the accessory storage to the body.

Optionally, the selectively coupling includes selectively coupling the accessory storage to a reservoir of the handheld oral health device.

Optionally, the method includes opening a closure of the accessory storage to access the one or more accessories positioned within a compartment of the accessory storage. The opening the closure may include rotating a lid about a hinge.

Optionally, the method includes detaching the accessory storage from the body.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments described herein and should not be construed as a complete depiction of the scope of the disclosure.

FIG. 1 is a perspective view of an example oral health device.

FIG. 2A is a perspective view of an oral health device including an example accessory storage.

FIG. 2B is a perspective view of the accessory storage of FIG. 2A removed from the oral health device.

FIG. 3A is a perspective view of an oral health device including another example accessory storage.

FIG. 3B is a bottom view of the accessory storage of FIG. 3A.

FIG. 4A is a perspective view of an oral health device including another example accessory storage.

FIG. 4B is a bottom view of the accessory storage of FIG. 4A.

FIG. 5A is a perspective view of an oral health device including another example accessory storage.

FIG. 5B is a perspective view of the accessory storage of FIG. 5A removed from the oral health device.

FIG. 6A is a perspective view of an oral health device including another example accessory storage.

FIG. 6B is a perspective view of the accessory storage of FIG. 6A removed from the oral health device.

FIG. 7 is a perspective view of another oral health device including an example accessory storage.

FIG. 8 is a flow chart of an example method of attaching an accessory storage to a handheld oral health device.

### DETAILED DESCRIPTION

The present disclosure provides various examples of handheld oral health devices (e.g., a water flosser, oral irrigator, electric toothbrush, etc.) having storage for various accessories, e.g., oral irrigation tips, brush heads, adapters, covers, etc.). The oral health device may be configured as a portable device (e.g., battery-powered, cordless device) and may include various features and components to enhance ergonomics and usability of the device and to improve the performance of the device, increasing portability, and form factor.

The oral health device may include a body and a refillable reservoir. Accessories, such as different types or replacement tips may be selectively attached to, and removed from, the oral health device. When not in use, one or more accessories may be stored in an accessory storage associated with the reservoir, handle, or other portion of the device. The accessory storage may be clipped, snapped, or otherwise releasably secured to the handheld device, such as through magnetic coupling, releasable connectors, or the like. In some embodiments, the accessory storage may be molded or otherwise formed with the reservoir (e.g., molded with the reservoir as a single piece or part), such as to prevent loss of the accessory storage.

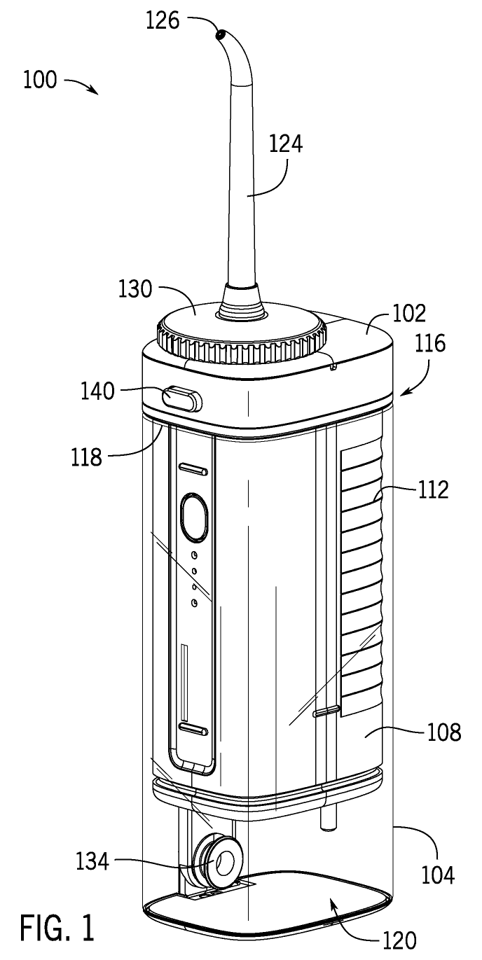

FIG. 1 is a perspective view of an example oral health device 100. The oral health device 100 may be implemented as a water flosser or oral irrigator, although other configurations are contemplated. The oral health device 100 has a body 102 and a refillable reservoir 104 for storing fluid. The body 102 and reservoir 104 may be ergonomically shaped for handheld use, such as the body 102 and/or reservoir 104 may be shaped such that a user can comfortably grasp the oral health device 100 (e.g., about the body 102 or the reservoir). For example, the reservoir may define a handle 108 for gripping by the user to hold the oral health device 100. The handle 108 may be defined by the shape or size of the reservoir body itself (e.g., the reservoir 104 configured for grasping by the user, the reservoir 104 having a small form factor for gripping, the reservoir 104 having a comfortable fit in the user’s hand, etc.). In some examples, the oral health device 100 may include gripping features 112 (e.g., ribs, grooves, knurling, etc.) configured to provide a gripping surface or otherwise facilitate a user’s grip with the oral health device 100. The gripping features 112 may be defined on the body 102 and/or the reservoir 104. In this manner, the oral health device 100 may be configured for handheld use (e.g., the oral health device 100 is a handheld device).

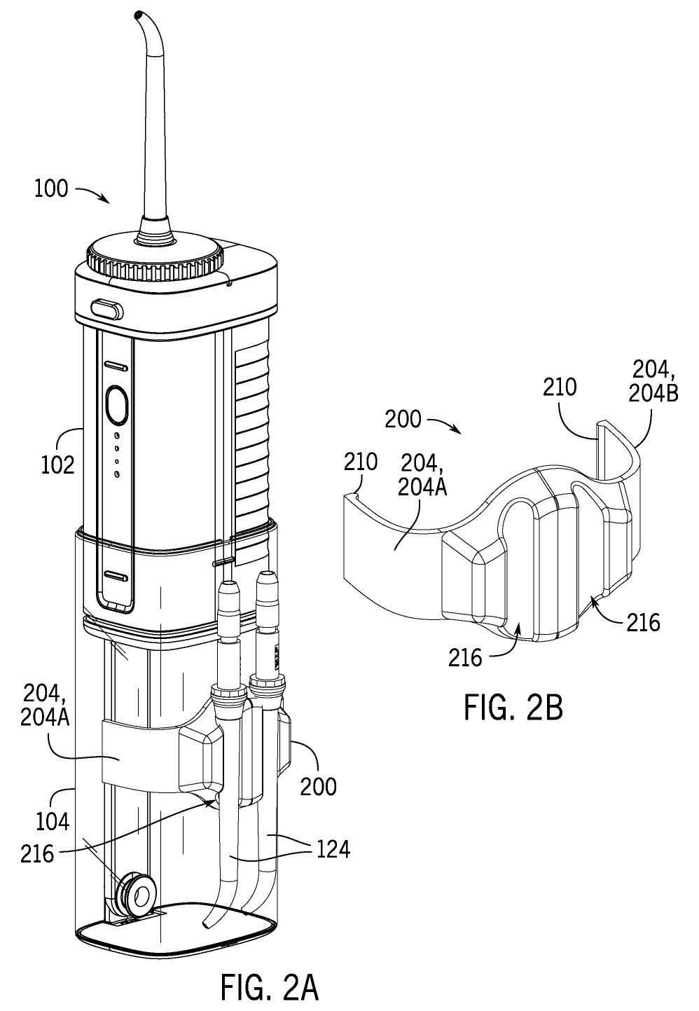

The reservoir 104 may be coupled to the body 102 (e.g., the reservoir 104 may be removable from the body 102). For example, the reservoir 104 may have an open top 116 (e.g., defined by a rim 118). The body 102 may be received within the open top 116. In examples, the body 102 may slide within the reservoir 104, such as to change the oral health device 100 between storage and use configurations. In a storage configuration (e.g., as shown in FIG. 1), the body 102 (or at least portions thereof) may be positioned within the reservoir 104, such as to collapse the oral health device 100 for compactness. In a use configuration (e.g., as shown in FIG. 2), the reservoir 104 may slide along the body 102, such as to expand a volume 120 for storing fluid beneath the body 102 and within the reservoir 104. In examples, the rim 118 or other portions of the reservoir 104 may seal against the body 102 to limit leakage of fluid through the interface between the reservoir 104 and body 102. The reservoir 104 may provide a stable platform to keep the oral health device 100 in an upright or vertical orientation when the oral health device 100 is placed on a supporting surface, such as a table or a countertop.

With continued reference to FIG. 1, the oral health device 100 may include a tip 124 having an outlet 126 through which pressurized fluid passes during operation of the oral health device 100. The tip 124 may be coupled with a cap 130. The tip 124 may be non-rotatably coupled to the cap 130 such that the tip 124 and the cap 130 rotate in unison (e.g., as a single unit) relative to the body 102. In such examples, rotation of the cap 130 rotates the tip 124. Rotation of the tip 124 enables the outlet 126 to be selectively positioned by a user so that the direction of the fluid stream exiting the outlet 126 may be altered during use and tailored to a user’s preferences.

A fill port 134 may be associated with the reservoir 104, providing an opening to the reservoir 104 enabling a user to fill the reservoir 104 with a fluid. When the reservoir 104 is filled to a desired level, the fill port 134 may be closed to seal the opening and prevent the fluid from spilling out of the reservoir 104 when the oral health device 100 is placed in a variety of different orientations during use. In one embodiment, the fill port 134 may be positioned at or near the bottom of the reservoir 104, although other configurations are contemplated.

The oral health device 100 may include an ejector button 140 used to actuate a latch or other retention mechanism to release the tip 124 from the oral health device 100. The ejector button 140 may be located adjacent the tip 124 and configured to be displaced in a direction generally towards the body 102 of the oral health device 100. When the ejector button 140 is actuated, the tip 124 may be removed from the oral health device 100, such as for replacement or to couple a different tip to the oral health device 100.

FIG. 2A is a perspective view of the oral health device 100 including an example accessory storage 200. FIG. 2B is a perspective view of the accessory storage 200. Accessory storage 200 may be associated with the body 102 or reservoir 104 of the oral health device 100, such as to conveniently store one or more accessories (e.g., tips 124, covers for the tips 124, user color code rings, adapters, or any other type of accessory for the oral health device 100) with the oral health device 100. In the embodiment of FIG. 2A, the accessory storage 200 includes an engagement configured for selective attachment to the reservoir 104 or another portion of the oral health device 100 gripped by the user. For example, the accessory storage 200 may include side portions 204 (e.g., a first side portion 204A and a second side portion 204B) shaped to fit around at least a portion of the reservoir 104. The side portions 204 may selectively engage the reservoir 104 to couple the accessory storage 200 to the reservoir 104. For instance, the side portions 204 may be configured to snap onto the reservoir 104 through clip and groove features and/or held in place with magnets, among other methods of selective attachment. As a result, the accessory storage 200 may be detachable from the body 102 or reservoir 104, such as detachable from the handle 108.

As one implementation, each side portion 204 may include a tab 210 (see FIG. 2B). The tabs 210 may be positioned within corresponding grooves or notches defined in the reservoir 104 to couple (e.g., snap) the accessory storage 200 to the reservoir 104. The grooves/notches may include a length configured to allow the accessory storage 200 to slide along the reservoir 104, such as to position the accessory storage 200 based on tip size, grip preference, etc. As a result, the accessory storage 200 may be configured to clip onto the reservoir 104 in multiple locations. In other examples, the length of the grooves/notches may match the tabs 210, such as to set the position of the accessory storage 200 on the reservoir 104. Although described with reference to snapping onto the reservoir 104 with clip and groove features, the accessory storage 200 may be held in place with magnets, snap-fit connections, clamps, latches, or other methods of releasable securement.

In examples, the accessory storage 200 may be configured to store one or more tips 124, among other accessories, for the oral health device 100. For example, in the implementation of FIGS. 2A-2B, the accessory storage 200 may include one or more grooves 216 to receive and hold one or more tips 124. For instance, the accessory storage 200 may include two grooves 216 to receive and hold two tips 124, although other configurations are contemplated. The grooves 216 may be shaped to match the tips 124, so that the grooves 216 grip the tips 124 for secure storage.

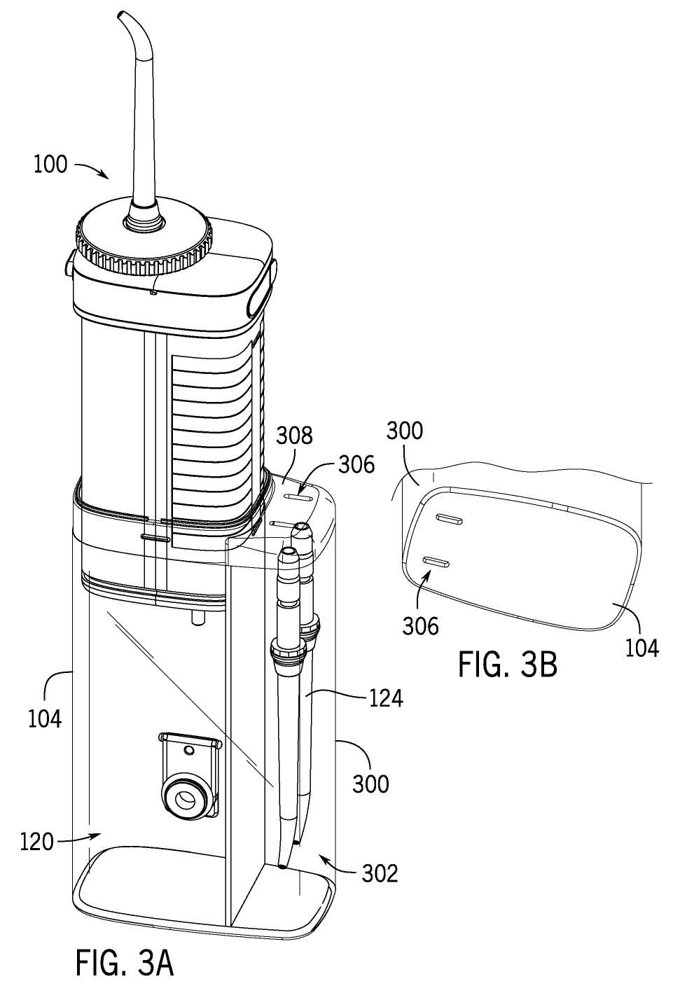

FIG. 3A is a perspective view of the oral health device 100 including another example accessory storage 300. FIG. 3B is a bottom view of the accessory storage 300. Except as otherwise noted below, the accessory storage 300 may be similar to the accessory storage 200, described above. For example, the accessory storage 300 may be configured to store one or more oral health accessories (e.g., tips 124) for the oral health device 100.

Rather than releasably or detachably connected to the reservoir 104, the accessory storage 300 may be molded into a side of the reservoir 104. For example, the accessory storage 300 may be molded into a back side (as shown in FIG. 3A), a front side, a left side, or a right side of the reservoir 104. In such examples, the accessory storage 300 may define a storage compartment 302 separate from the volume 120 of the reservoir 104 for storing fluid. The storage compartment 302 may be configured to receive one or more accessories for the oral health device 100 (e.g., tips 124).

Referring to FIG. 3B, the accessory storage 300 may include venting 306 (e.g., one or more vents or holes). The venting 306 may be defined at a bottom of the storage compartment 302, such as through a bottom wall or surface, so as to drain liquid from the storage compartment 302 away from the oral health device 100 (e.g., liquid from the tips 124 positioned within the storage compartment 302). Depending on the application, the venting 306 may include slots or holes. Referring to FIG. 3A, in some examples, the accessory storage 300 may include a closure 308 (e.g., a lid). The closure 308 may be configured to selectively close the storage compartment 302. In addition, or alternatively, the closure 308 may be configured to allow selective access to the one or more tips 124 in the storage compartment 302. For example, the closure 308 may be opened to insert one or more tips 124 into, or remove one or more tips 124 from, the storage compartment 302. In the implementation of FIG. 3A, the closure 308 is hinged at a top of the storage compartment 302 (e.g., to selectively close a top of the accessory storage 300), although other configurations are contemplated. In examples, venting 306 may be defined in the closure 308.

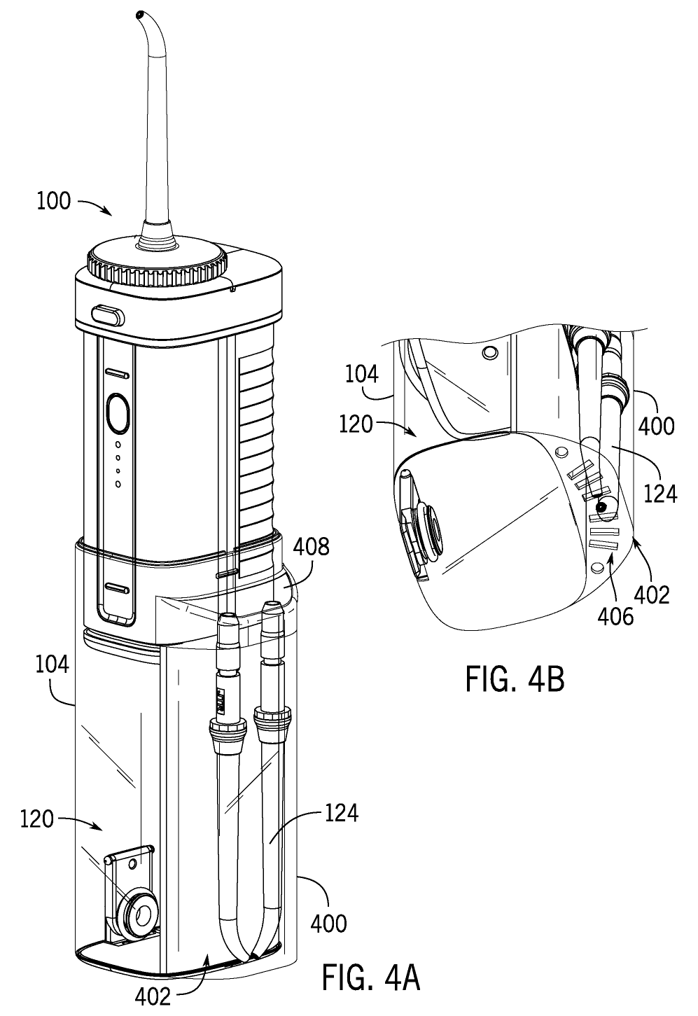

FIG. 4A is a perspective view of the oral health device 100 including another example accessory storage 400. FIG. 4B is a bottom view of the accessory storage 400. Except as otherwise noted below, the accessory storage 400 may be similar to the accessory storage 200 or 300, described above. For example, the accessory storage 400 may be configured to store one or more oral health accessories (e.g., tips 124) for the oral health device 100. Like accessory storage 300, the accessory storage 400 may be molded into a side of the reservoir 104. For example, the accessory storage 400 may be molded into a left or right side of the reservoir 104. Like accessory storage 300, the accessory storage 400 may define a storage compartment 402 separate from the volume 120 of the reservoir 104 for storing fluid, the storage compartment 402 configured to receive one or more accessories (e.g., tips 124).

Referring to FIG. 4B, venting 406 may be defined at a bottom of the storage compartment 402. In examples, the venting 406 may include a combination of slots and holes. Referring to FIG. 4A, a closure 408 (e.g., a lid) may be configured to selectively close the storage compartment 402 (e.g., via rotation about a hinge) and allow selective access to the one or more tips 124 in the storage compartment 402, such as at a top of the storage compartment 402, although other configurations are contemplated.

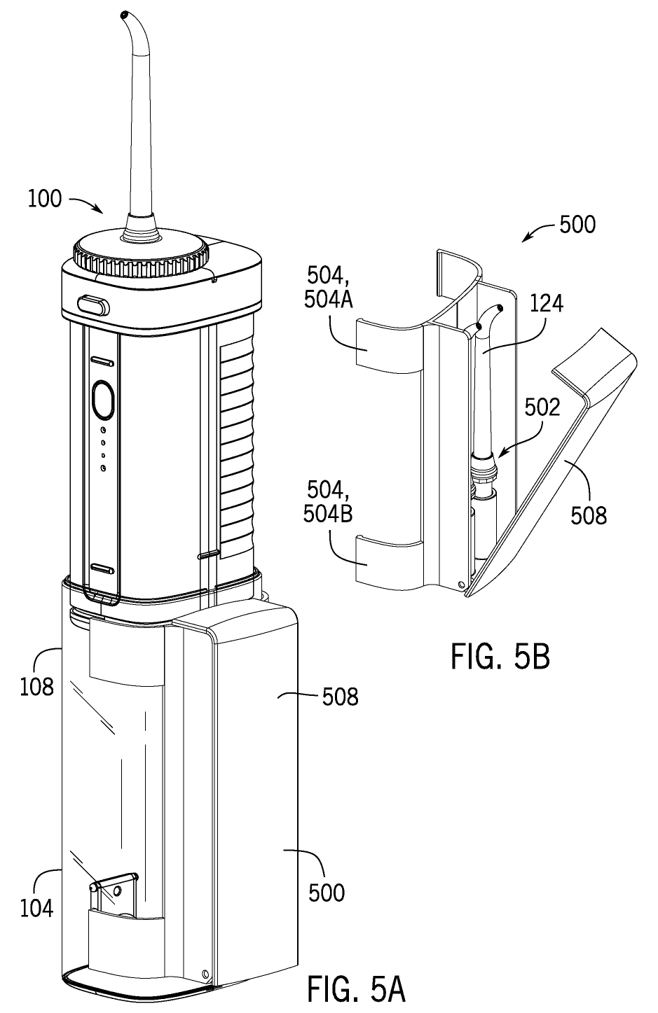

FIG. 5A is a perspective view of the oral health device 100 including another example accessory storage 500. FIG. 5B is a perspective view of the accessory storage 500. Except as otherwise noted below, the accessory storage 500 may be similar to the accessory storage 200, 300, or 400, described above. For example, the accessory storage 500 may be configured to store one or more oral health accessories (e.g., tips 124) for the oral health device 100.

Like accessory storage 200, the accessory storage 500 may be releasably or detachably connected to the reservoir 104. For example, the accessory storage 500 may include multiple clips 504 (e.g., a first clip 504A and a second clip 504B) shaped to fit around and engage at least portions of the reservoir 104. Similar to side portions 204, the clips may be configured to snap into corresponding grooves or notches of the reservoir 104, so that the accessory storage 500 is detachable from the reservoir 104 or handle 108. For example, the first clip may snap to a first location on the reservoir 104, and the second clip may snap to a second location on the reservoir 104, such as at or near the top and bottom of the reservoir 104. As a result, the accessory storage 500 may be configured to clip onto the reservoir 104 in multiple locations.

The accessory storage 500 may include a closure 508 (e.g., a lid) configured to selectively close a storage compartment 502 housing one or more tips 124 (see FIG. 5B). In the implementation of FIG. 5B, the closure 508 is hinged at a bottom of the storage compartment 502, although other configurations are contemplated. For instance, the closure 508 may be hinged at the top of the storage compartment 502 or the closure 508 may slide to open. The closure 508 may be snap or magnetic. For example, the closure 508 may snap or otherwise engage the body of the accessory storage 500 to secure the closure 508 in a closed position. In other examples, magnets may be used to hold the closure 508 shut.

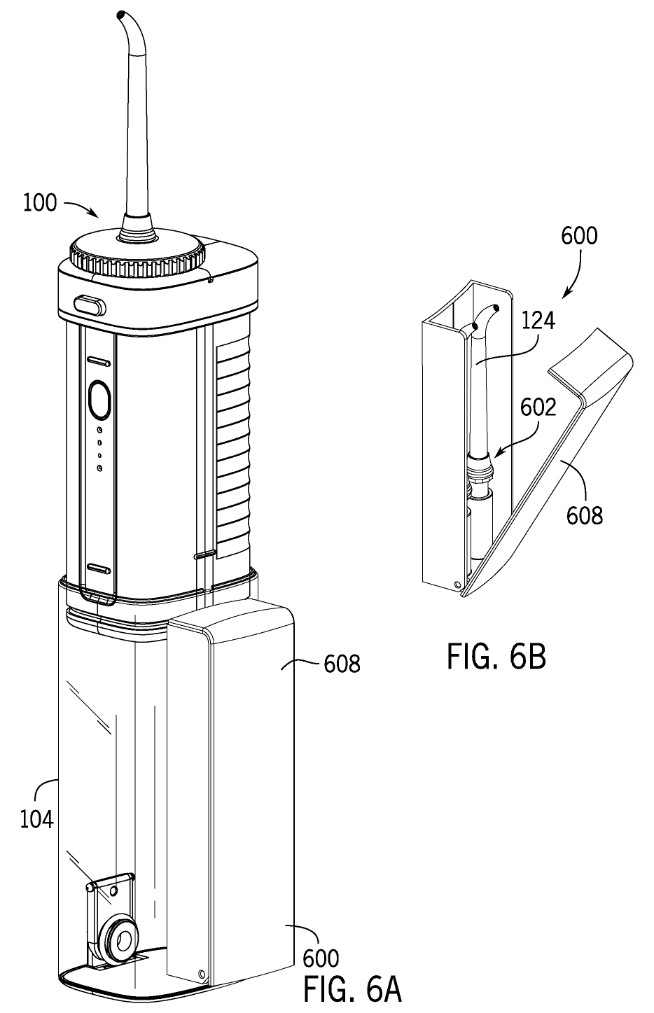

FIG. 6A is a perspective view of the oral health device 100 including another example accessory storage 600. FIG. 6B is a perspective view of the accessory storage 600. Except as otherwise noted below, the accessory storage 600 may be similar to the accessory storage 200, 300, 400, or 500, described above. For example, the accessory storage 600 may be configured to store one or more oral health accessories (e.g., tips 124) for the oral health device 100. Like accessory storage 500, the accessory storage 600 may include a hinged or slide closure 608, such as to provide access to one or more tips 124 within a storage compartment 602 housing one or more tips 124 (see FIG. 6B).

Like accessory storage 200 and 500, the accessory storage 600 may be releasably or detachably connected to the reservoir 104. Rather than a snap engagement, however, the engagement may include magnets to magnetically couple the accessory storage 600 to the reservoir 104 or body 102 (e.g., to the side of the reservoir 104). Such configurations may provide convenience for the user and a compact design. In addition, the configurations of FIGS. 6A-6B may result in a more freestanding storage when detached from the reservoir 104.

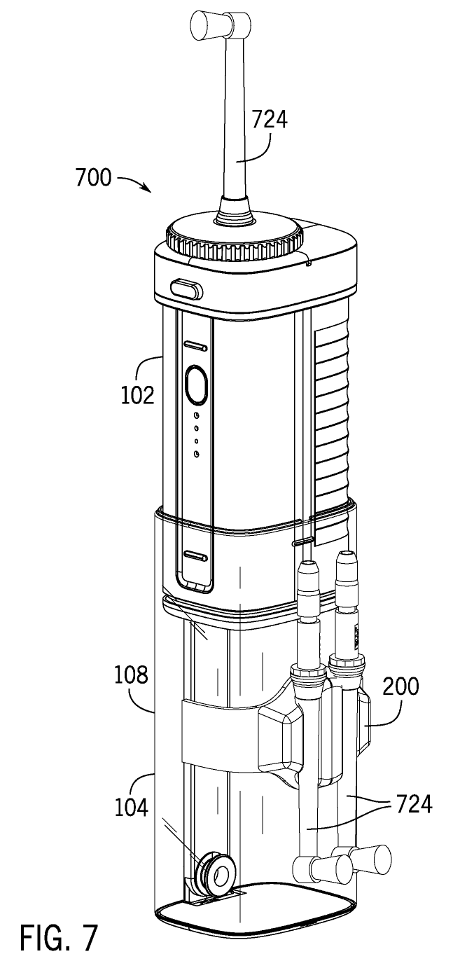

FIG. 7 is a perspective view of another oral health device 700 including accessory storage (e.g., accessory storage 200). The accessory storage concepts described herein may be applied to other handheld oral health devices. For example, the accessory storage concepts may be applicable to electric toothbrushes having replaceable brush heads 724, or combination devices having both irrigation and brushing functions. Thus, the oral health device 700 may be implemented as an electric toothbrush. In such examples, the accessory storage 200, 300, 400, 500, or 600 may store one or multiple brush heads 724, or a combination of tips 124 and brush heads 724. Although FIG. 7 illustrates the oral health device 700 having a reservoir (e.g., to provide oral irrigation functions during brushing or otherwise), the reservoir may be omitted, with the accessory storage 200, 300, 400, 500, or 600 detachably coupled to the body 102 or handle 108 of the handheld device. As a result, the accessory storage 500 or 600 may define a storage compartment separate from the handle 108.

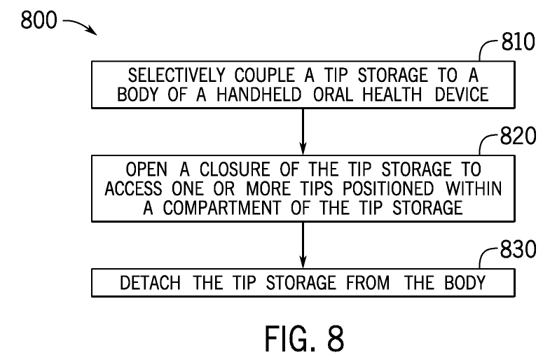

FIG. 8 is a flow chart of an example method 800 of attaching an accessory storage to a handheld oral health device. Any of the steps may be omitted, and the steps may be performed in any order, such that the method is not limited to any particular order or sequence.

At step 810, the method 800 includes selectively coupling an accessory storage (e.g., any one of accessory storage 200, 300, 400, 500, or 600) to a body of a handheld oral health device (e.g., oral health device 100 or oral health device 700). In examples, the accessory storage is configured to store one or more tips (e.g., tip 124) for the handheld oral health device, such as in a manner as described above. The tips may include an irrigator tip, a jet tip, an orthodontic tip, a brush head or toothbrush tip, a tongue cleaner tip, a whitening tip, or any other tip designed for use with the handheld oral health device.

Step 810 may include snapping the accessory storage onto the body of the handheld oral health device. For example, accessory storage 200 or 500 may be snapped onto body 102, such as via side portions 204 or clips engaging the handheld oral health device, such as in a manner as described above. Step 810 may include magnetically coupling the accessory storage to the body of the handheld oral health device. For instance, accessory storage 600 may be magnetically coupled to the side of the handheld oral health device. In examples, step 810 includes selectively coupling the accessory storage to a reservoir (e.g., reservoir 104) of the handheld oral health device.

At step 820, the method 800 includes opening a closure of the accessory storage to access one or more tips positioned within a compartment of the accessory storage. In examples, step 820 may include rotating a lid about a hinge, such as in a manner as described above with reference to FIGS. 3A, 4A, 5B, and 6B. Opening the closure may allow one or more tips to be inserted or removed from the accessory storage. Closing the closure may close the accessory storage, such as to limit removal or loss of the tips stored therein.

At step 830, the method includes detaching the accessory storage from the body of the handheld oral health device. For example, any of accessory storage 200, 300, 400, 500, or 600 may be removed from the handheld oral health device, such as for storage, cleaning, replacement, to couple to a different handheld device, or to couple a different accessory storage to the device.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader’s understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A handheld oral health device comprising:
a body;
a reservoir coupled to the body and defining a handle for gripping by the user to hold the handheld oral health device; and
an accessory storage associated with the reservoir, the accessory storage configured to store one or more accessories for the handheld oral health device.

2. The handheld oral health device of claim 1, wherein the accessory storage comprises side portions shaped to fit around at least a portion of the reservoir, and wherein the side portions selectively engage the reservoir to couple the accessory storage to the reservoir.

3. The handheld oral health device of claim 2, wherein the side portions are configured to snap onto the reservoir through clip and groove features.

4. The handheld oral health device of claim 1, wherein the accessory storage is molded into a side of the reservoir.

5. The handheld oral health device of claim 4, further comprising:
a lid to selectively close a top of the accessory storage; and
venting defined at a bottom of the accessory storage.

6. The handheld oral health device of claim 1, wherein the accessory storage is configured to clip onto the reservoir in multiple locations.

7. The handheld oral health device of claim 6, wherein the accessory storage comprises first and second clips shaped to fit around and engage at least portions of the reservoir.

8. The handheld oral health device of claim 6, wherein the accessory storage comprises a lid that opens to allow access to the one or more accessories.

9. The handheld oral health device of claim 8, wherein the lid comprises a closure that is snap or magnetic.

10. The handheld oral health device of claim 1, wherein the accessory storage is coupled to the reservoir using magnets.

11. The handheld oral health device of claim 1, wherein the reservoir is removable from the body.

12. A handheld device for oral health, the handheld device comprising:
a body; and
an accessory storage associated with the body and configured to store one or more accessories for the handheld device,
wherein the accessory storage is detachable from the body and/or defines a storage compartment separate from the body.

13. The handheld device of claim 12, wherein the accessory storage comprises a hinged or slide closure.

14. The handheld device of claim 12, wherein the body comprises a handheld reservoir, and wherein the accessory storage is detachable from the reservoir and/or defines a storage compartment separate from the reservoir.

15. The handheld device of claim 12, wherein the body comprises a handle, and wherein the accessory storage is detachable from the handle and/or defines a storage compartment separate from the handle.

16. An accessory storage configured for selective attachment to a reservoir of a handheld oral health device, the reservoir defining a handle for holding the handheld oral health device, the accessory storage comprising:
an engagement configured for selective attachment to the reservoir; and
a storage to receive and hold one or more accessories for the handheld oral health device.

17. The accessory storage of claim 16, wherein the engagement comprises a clip configured to snap into a corresponding groove or notch of the reservoir.

18. The accessory storage of claim 16, wherein the engagement comprises magnets to magnetically couple the accessory storage to the reservoir.

19. The accessory storage of claim 16, wherein the storage comprises one or more grooves to receive and hold the one or more accessories.

20. The accessory storage of claim 16, wherein the storage comprises:
a compartment to receive the one or more accessories; and
a hinged or slide closure configured to selectively close the compartment.
